(19) United States
(12) Patent Application Publication
(10) Pub. No.: US 2018/0017239 A1
(43) Pub. Date: Jan. 18, 2018

(54) COMPATIBLE DOWNLIGHT

(71) Applicant: SHENZHEN JIAWEI PHOTOVOLTAIC LIGHTING CO., LTD.

(72) Inventors: Zhiyong LIU, Shenzhen (CN); Bo YAN, Shenzhen (CN); Xichun ZHANG, Shenzhen (CN)

(21) Appl. No.: 15/112,372

(22) PCT Filed: Apr. 26, 2016
(86) PCT No.: PCT/CN2016/080236

§ 371 Date: Jul. 18, 2016

(51) Int. Cl. F21V 21/04; F21S 8/02; F21V 23/00; F21V 23/06

(52) U.S. Cl. CPC F21V 21/04; F21V 23/06; F21S 8/026; F21V 23/001

(57) ABSTRACT

A compatible downlight is mounted in a mounting hole (90) of a ceiling (9), the compatible downlight comprises a lamp body (1) and a first conducting wire (2) led out from an inside of the lamp body (1) and electrically connected with the lamp body (1); the compatible downlight further comprises a wiring component (3) configured to connect with an external power supply and two elastic members (4) configured for positioning and fixing the lamp body (1); each of the elastic members (4) can be fixedly connected to and detached from the lamp body (1); in addition, the first conducting wire (2) is electrically connected with the wiring component (3). The compatible downlight provided by the embodiment of the present invention can be compatible with both assembly with a mounting cylinder and assembly without any mounting cylinder, and can also be compatible with assemblies using different hole diameters of mounting holes, such that using requirements of consumers are met, using cost is reduced, and experience effect of the consumers is improved.

### TECHNICAL FIELD

The present application relates to the technical field of structures of lamps, and more particularly, relates to a compatible downlight.

### BACKGROUND

A downlight is a type of lighting lamp that is embedded in a ceiling and emits light downwardly, and is usually widely used in hotels, households, and coffee houses. In a household, the downlight is generally arranged in a peripheral ceiling of a bedroom, a living room or a restroom. The biggest characteristic of the downlight is that the downlight can maintain entire unification and perfection of an architectural decoration, and a perfect unification of hung ceiling art will not be ruined by an arrangement of lighting lamps. This kind of hidden lighting lamp embedded in an interior of a ceiling emits all lights thereof downwardly, which belongs to direct light distribution. The downlight doesn't occupy space, and can add comfortable atmosphere of the space; if a sweet feeling needs to be created, it is possible to try to arrange many downlights so as to reduce a spatial oppressive feeling.

An existing downlight is generally a single utilization structure with a mounting cylinder or without any mounting cylinder; moreover, as for a downlight without any mounting cylinder, a size of a mounting hole and a thickness of a wall of a ceiling can't be adjusted according to requirements; when a consumer assembles and uses a downlight, he/she must choose many kinds of downlights with different functionalities and sizes such that assembling and using requirements can be met. As a result, the use cost may be relatively higher. Therefore, how to provide a compatible downlight, which is compatible with both assembly with a mounting cylinder and assembly without any mounting cylinder, and can adjust a hole diameter of a mounting hole, is a technical problem that needs to be solved immediately by the downlight industry.

### BRIEF SUMMARY

In order to overcome the aforesaid defects in the prior art, a purpose of the present invention is providing a compatible downlight, which can be compatible with both assembly with a mounting cylinder and assembly without any mounting cylinder, and can also be compatible with assemblies using different hole diameters of mounting holes, such that using requirements of consumers are met, use cost is reduced, and experience effect of consumers is improved.

An embodiment of the present invention provides a compatible downlight mounted in a mounting hole of a ceiling; the compatible downlight comprises a lamp body and a first conducting wire led out from an inside of the lamp body and electrically connected with the lamp body; the compatible downlight further comprises a wiring component configured to connect with an external power supply and two elastic members configured for positioning and fixing the lamp body, each of the elastic members is fixedly connected to and detachable from the lamp body, and the first conducting wire is electrically connected to the wiring component.

In one embodiment of the present invention, the compatible downlight further comprises a mounting cylinder which defines an opening at a bottom end thereof and is hollow, the mounting cylinder is mounted in the mounting hole of the ceiling, both the wiring component and the lamp body are arranged in the mounting cylinder, and a bottom surface of the lamp body blocks the opening of the mounting cylinder.

Furthermore, the wiring component comprises a lamp base arranged on an inner wall of a top end of the mounting cylinder, a lamp cap connected in the lamp base, and a second conducting wire electrically connected with the lamp cap, and the second conducting wire is electrically connected with the first conducting wire.

Furthermore, an outer end of the first conducting wire is provided with a female terminal and an outer end of the second conducting wire is provided with a male terminal; or the outer end of the first conducting wire is provided with a male terminal and the outer end of the second conducting wire is provided with a female terminal; the male terminal is inserted in the female terminal to form an electrical connection.

Furthermore, each of the elastic members comprises a first connecting sheet and two abutting elastic members integrally arranged at two sides of the first connecting sheet respectively, the first connecting sheet can be fixedly connected to and detached from an outer wall of the lamp body, and the abutting elastic members abuts tightly against an inner wall of the mounting cylinder.

In another embodiment of the present invention, an inner peripheral wall of the mounting cylinder protrudes to form two hangers, and the two elastic members are hung on the two hangers respectively.

Further, each of the elastic members comprises a second connecting sheet and a torque spring arranged at an outer side of the second connecting sheet, and two support legs of the torque spring abut tightly against and fit with one of the hangers to form a hitching connection.

In another embodiment of the present invention, the wiring component comprises a wiring box arranged on a top part of the lamp body and a third conducting wire, and an inner end of the third conducting wire extends into the wiring box and is electrically connected with the first conducting wire.

Further, the wiring component further comprises a wiring sleeve communicated with the wiring box, and an outer end of the third conducting wire inserts in and passes through the wiring sleeve.

Furthermore, the third conducting wire and the first conducting wire form the electrical connection through a wiring nut.

Based on the aforesaid technical solutions, the compatible downlights provided by the embodiments of the present invention are compatible with both an assembly type with the mounting cylinder and an assembly type without any mounting cylinder; moreover, the compatible downlights are also compatible with assemblies using different hole diameters of mounting holes, such that using requirements of consumers are met, using cost is reduced, and experience effect of the consumers is improved.

### BRIEF DESCRIPTION OF THE DRAWINGS

FIG. 1 illustrates a structural schematic view of a cross section of a compatible downlight provided by a first embodiment of the present invention;

FIG. 2 illustrates a disassembled structural schematic view of the compatible downlight provided by the first embodiment of the present invention;

FIG. 3 illustrates a structural schematic view of an elastic member in the first embodiment of the present invention;

FIG. 4 illustrates a structural schematic view of a cross section of a compatible downlight provided by a second embodiment of the present invention;

FIG. 5 illustrates a disassembled structural schematic view of the compatible downlight provided by the second embodiment of the present invention;

FIG. 6 illustrates a structural schematic view of an elastic member in the second embodiment of the present invention;

FIG. 7 illustrates a structural schematic view of a cross section of a compatible downlight provided by a third embodiment of the present invention;

FIG. 8 illustrates a disassembled structural schematic view of the compatible downlight provided by the third embodiment of the present invention;

FIG. 9 illustrates a structural schematic view of an elastic member in the third embodiment of the present invention.

### DETAILED DESCRIPTION OF THE PREFERRED EMBODIMENT

In order to make the purpose, the technical solution and the advantages of the present application be clearer and more understandable, the present invention will be further described in detail hereinafter with reference to accompanying drawings and embodiments. It should be understood that the specific embodiments described herein are used to illustrate the present application merely, rather than limiting the present invention.

It needs to be noted that, when one component is described as “fixed to” or “mounted on” another component, this component can be directly located on another component, or an intermediate component may exist simultaneously. When one component is described as “connected with” another component, this component can be directly connected with another component, or an intermediate component may exist simultaneously.

In addition, it needs to be further noted that, position terms in the embodiments of the present invention, such as left, right, up, down, and so on, are only mutual relative concepts or take a normal using state of a product as reference, and should not be regarded as being restrictive. An implementation of the present invention will be described in detail hereinafter with reference to the specified embodiments.

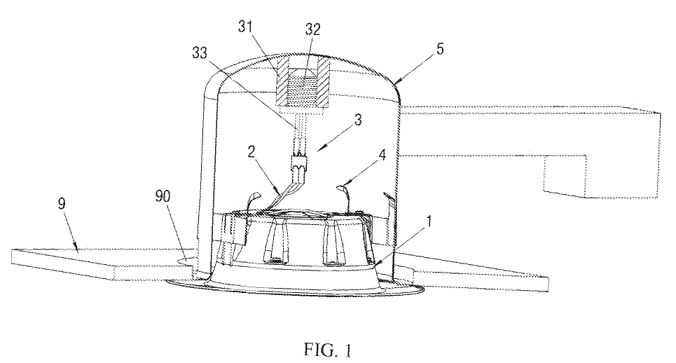

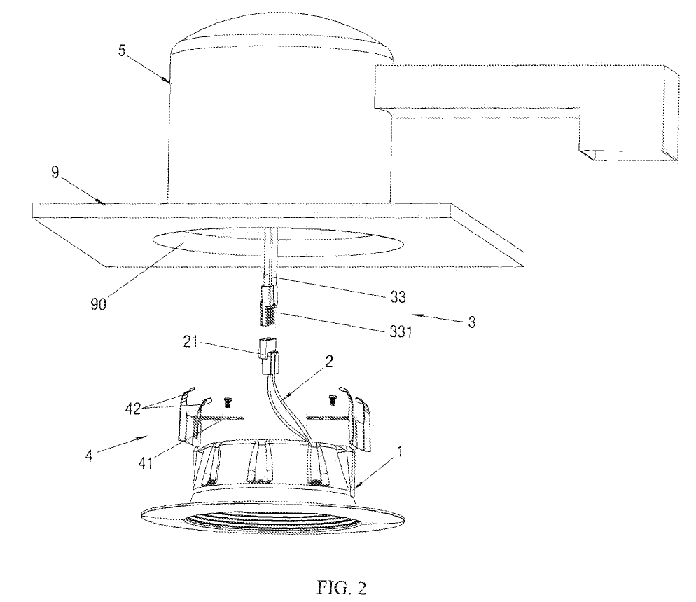

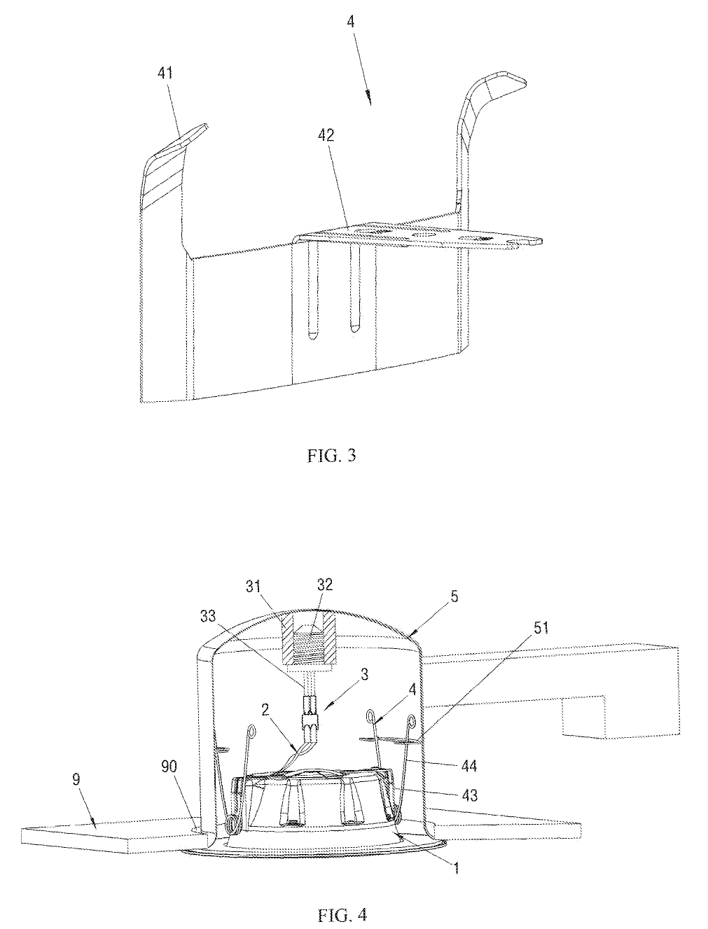

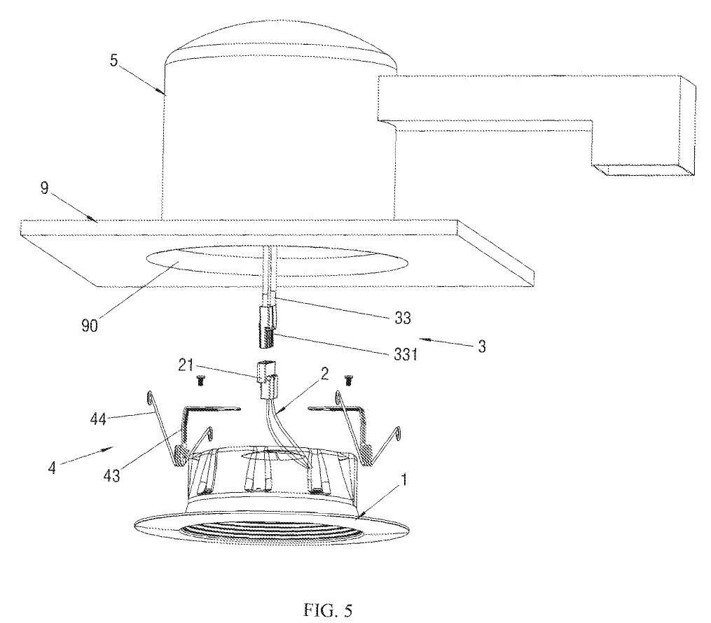

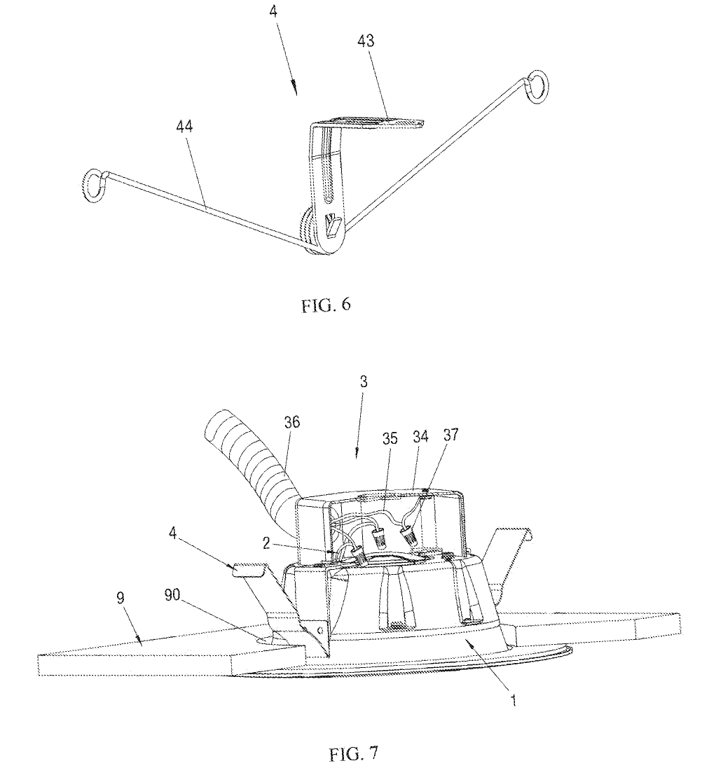

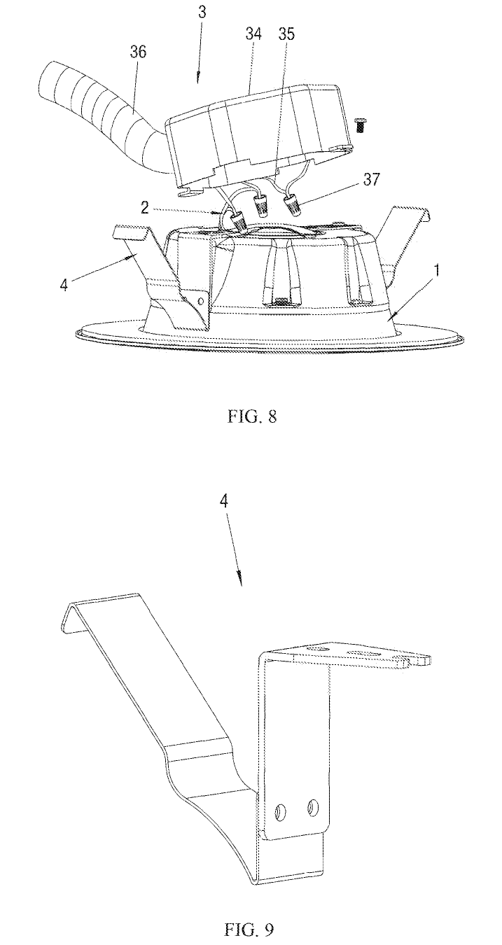

As shown in FIGS. 1-9, the present invention provides a compatible downlight that is mounted in a mounting hole 90 of a ceiling 9. Specifically, the compatible downlight can comprise a lamp body 1, a first conducting wire 2, a wiring component 3, and an elastic member 4; wherein, the first conducting wire 2 is led out from an inside of the lamp body 1 and is electrically connected with the lamp body 1, an outer end of the first conducting wire 2 is electrically connected to the wiring component 3, and the wiring component 3 is configured to connect to an external power supply; in addition, the elastic member 4 is fixedly connected to and detachable from the lamp body 1, here, the elastic member 4 is configured for positioning and fixing the lamp body 1.

### Embodiment One, as Shown in FIGS. 1-3

In this embodiment, the compatible downlight further comprises a mounting cylinder 5, the mounting cylinder 5 is preferably a cylindrical structure that defines an opening at a bottom end thereof and is hollow, and the mounting cylinder 5 is mounted in the mounting hole 90 of the ceiling 9. Here, both the wiring component 3 and the lamp body 1 are arranged in the mounting cylinder 5, and a bottom surface of the lamp body 1 blocks the opening of the mounting cylinder 5.

Further, in the embodiment of the present invention, the aforesaid wiring component 3 can comprise a lamp base 31, a lamp cap 32 and a second conducting wire 33, wherein, the lamp base 31 is arranged on an inner wall of a top end of the mounting cylinder 5; the lamp base 31 is provided with an internal thread, the lamp cap 32 is provided with an external thread, and the lamp cap 32 extends into the lamp base 31 and is fixedly connected with the lamp base 31 by a thread fitting; in addition, the second conducting wire 33 is led out from the inside of the lamp cap 32 and is electrically connected with the lamp cap 32, and an outer end of the second conducting wire 33 is electrically connected with the first conducting wire 2; in this way, an electrical connection is formed between the lamp cap 32 and the lamp body 1. Of course, according to actual conditions and specific requirements, in other embodiments of the present invention, the aforesaid wiring component 3 can also be in other forms, and is not uniquely restricted here.

Furthermore, in the embodiment of the present invention, an outer end of the aforesaid first conducting wire 2 is provided with a female terminal 21, an outer end of the second conducting wire 33 is provided with a male terminal 331, and the first conducting wire 2 and the second conducting wire 33 form an electrical connection by a plug connection between the female terminal 21 and the male terminal 331; or the outer end of the aforesaid first conducting wire 2 is provided with the male terminal, the outer end of the second conducting wire 33 is provided with the female terminal, and the first conducting wire 2 and the second conducting wire 22 form the electrical connection by the plug connection between the male terminal 331 and the female terminal 21. By the plug connection of the terminals, the first conducting wire 2 and the second conducting wire 33 can be assembled and disassembled rapidly and conveniently, and the electrical connection between the first conducting wire 2 and the second conducting wire 22 is stable and reliable. Of course, according to actual conditions and specific requirements, in other embodiments of the present invention, the aforesaid first conducting wire 2 and the aforesaid second conducting wire 33 can also be electrically connected by other methods.

Furthermore, in the embodiment of the present invention, the aforesaid elastic member 4 can comprise a first connecting sheet 41 and a pair of abutting elastic pieces 42, and the pair of abutting elastic pieces 42 are integrally arranged at a left side and a right side of the first connecting sheet 41 respectively. In assembly, the first connecting sheet 41 is fixedly connected to and detachable from an outer wall of the lamp body 1, here, the first connecting sheet 41 is provided with tapping holes (not shown in the drawings), by screws passing through these tapping holes, the first connecting piece 41 can be fixedly connected to the lamp body 1. Meanwhile, the abutting elastic pieces 42 elastically abut against the inner wall of the mounting cylinder 5, in this way, under the situation that the abutting elastic sheet 42 abuts tightly against and fits with the mounting cylinder 5, it is implemented that the lamp body 1 fixedly connected with the first connecting sheet 41 is positioned and fixed in the mounting cylinder 5. Of course, according to actual conditions and specific requirements, in other embodiments of the present invention, the aforesaid elastic member 4 can also be in other structure types, and it is not uniquely restricted here.

The aforesaid embodiment one is a half substitution type of the compatible downlight, and an assembling process of the downlight is as follows:

Firstly, an earless mounting cylinder with a size of five or six inches is selected to serve as a mounting cylinder 5 configured for participating in assembly, and then a lamp cap 32 in an accessory bag is screwed into the lamp base 31 inside the mounting cylinder 5; here, the lamp cap 32 is preferably an E26 lamp cap, of course, according to actual conditions and requirements, the lamp cap 32 can also be selected from other types; then, according to a size of the mounting cylinder 5, an elastic member 4 with a size of five inches or six inches is selected correspondingly, and screws are applied to the tapping holes on corresponding positions of the elastic member 4 so as to fix the elastic member 4 with the lamp body 1, here, in other words, the first connecting sheet 41 of the elastic member 4 is fixedly connected to the lamp body 1 by the screws; thus, the second conducting wire 33 and the first conducting wire 2 form an electrical connection by the plug connection between the male terminal 331 and the female terminal 21; afterwards, the elastic member 4 fixedly connected on the lamp body 1 is snapped into the earless mounting cylinder 5 and then fixed, here, in other words, the abutting elastic sheet 42 of the elastic member 4 is snapped into the mounting cylinder 5, and elastically abuts against and is fixed on the inner wall of the mounting cylinder 5; in this way, the lamp body 1 forms a fixation with the mounting cylinder 5; at this point, the whole downlight is completely assembled.

### Embodiment Two, as Shown in FIGS. 4-6

In this embodiment, a compatible downlight is provided, and the compatible downlight can comprise a lamp body 1, a first conducting wire 2, a wiring component 3, two elastic members 4 and a mounting cylinder 5, the mounting cylinder 5 is preferably a cylindrical structure that defines an opening at a bottom end thereof and is hollow, and the mounting cylinder 5 is mounted in an mounting hole 90 of a ceiling 9. Here, both the aforesaid wiring component 3 and the aforesaid lamp body 1 are arranged in the mounting cylinder 5, and a bottom surface of the lamp body 1 blocks the opening of the mounting cylinder 5.

The aforesaid wiring component 3 can comprise a lamp base 31, a lamp cap 32 and a second conducting wire 33, wherein, the lamp base 31 is arranged on an inner wall of a top end of the mounting cylinder 5, the lamp base 31 is provided with an internal thread, the lamp cap 32 is provided with an external thread, and the lamp cap 32 extends into the lamp base 31, and is fixedly connected with the lamp base 31 by a threaded fit; in addition, the second conducting wire 33 is led out from an inside of the lamp cap 32 and is electrically connected with the lamp cap 32, and an outer end of the second conducting wire 33 is electrically connected with the first conducting wire 2, in this way, an electrical connection is formed between the lamp cap 32 and the lamp body 1.

An outer end of the aforesaid first conducting wire 2 is provided with a female terminal 21, an outer end of the aforesaid second conducting wire 33 is provided with a male terminal 331, and the first conducting wire 2 and the second conducting wire 33 form an electrical connection by a plug connection between the female terminal 21 and the male terminal 331; or, the outer end of the aforesaid first conducting wire 2 is provided with the male terminal 331, the outer end of the aforesaid second conducting wire 33 is provided with the female terminal 21, and the first conducting wire 2 and the second conducting wire 33 form the electrical connection by the plug connection between the male terminal 331 and the female terminal 21. By the plug connection of terminals, the first conducting wire 2 and the second conducting wire 33 can be assembled and disassembled rapidly and conveniently, and the electrical connection between the first conducting wire 2 and the second conducting wire 33 is stable and reliable.

In this embodiment, an inner peripheral wall of the aforesaid mounting cylinder 5 protrudes to form a pair of hangers 51, here, the pair of hangers are symmetrically arranged at two sides of the inner peripheral wall of the mounting cylinder 5, and have a symmetrical axis that is a central axis of the mounting cylinder 5. In assembly, a pair of elastic members 4 fixedly connected to the lamp body 1 are hung on the pair of hangers 51 correspondingly; in this way, under a connection function of the elastic members 4 and the hangers 51, the lamp body 1 is fixed in the mounting cylinder 5.

Furthermore, in the embodiment of the present invention, each of the aforesaid elastic members 4 comprises a second connecting sheet 43 and a torque spring 44, and the torque spring 44 is connected at an outer side of the second connecting sheet 43. In assembly, the second connecting sheet 43 is fixedly connected to and detachable from an outer wall of the lamp body 1; here, the second connecting sheet 43 is provided with tapping holes (not shown in the drawings), by screws passing through these tapping holes such that the second connecting sheet 43 can be fixedly connected to the lamp body 1. Meanwhile, two support legs of the torque spring 44 abut tightly against and fit with the hangers 51 to form a hitching connection. In this way, under a situation that the torque spring 44 abuts tightly against and fits with the hangers 51 on the inner wall of the mounting cylinder 5, it is implemented that the lamp body 1 fixedly connected with the second connecting sheet 43 is positioned and fixed in the mounting cylinder 5. Of course, according to actual conditions and specific requirements, in other embodiments of the present invention, the aforesaid elastic member 4 can also be in other structure types, and it is not uniquely restricted here.

The aforesaid embodiment two is another half substitution type of the compatible downlight, and an assembling process of the compatible downlight is as follows:

Firstly, an eared mounting cylinder with a size of five or six inches is selected to serve as the mounting cylinder 5 configured for participating in assembly, that is, the mounting cylinder 5 is provided with hangers 51 therein. Afterwards, the lamp cap 32 in an accessory bag is screwed into the lamp base 5 inside the mounting cylinder 5; herein, the lamp cap 32 is preferably an E26 lamp cap, of course, according to actual conditions and the requirements, the lamp cap 32 can also be selected from other types; then, the elastic member 4 with a size of five or six inches is selected correspondingly according to the size of the mounting cylinder 5, and screws are applied to the tapping holes on corresponding positions of the elastic member 4 so as to fix the elastic member 4 with the lamp body 1, here, in other words, the second connecting sheet 43 of the elastic member 4 is fixedly connected to the lamp body 1 by the screws; thus, the second conducting wire 33 and the first conducting wire 2 form an electrical connection by the plug connection of the terminals; thus, the elastic member 4 fixedly connected to the lamp body 1 is snapped into the hangers 51 of the mounting cylinder 5 and then fixed, here, in other words, the torque spring 44 of the elastic member 4 is snapped into the corresponding hangers 51 and then fixed, such that the lamp body 1 is fixed with the mounting cylinder 5; at this point, the whole downlight is completely assembled.

### Embodiment Three, as Shown in FIGS. 7-9

In this embodiment, a compatible downlight comprises a lamp body 1, a first conducting wire 2, a wiring component 3, and an elastic member 4, wherein, the first conducting wire 2 is led out from an inside of the lamp body 1 and is electrically connected with the lamp body 1, an outer end of the first conducting wire 2 is electrically connected with the wiring component 3, and the wiring component 3 is configured to connect to an external power supply; in addition, the elastic member 4 is fixedly connected to and detachable from the lamp body 1, here, the elastic member 4 is configured for positioning and fixing the lamp body 1.

Furthermore, in this embodiment, the aforesaid wiring component 3 further comprises a wiring box 34 and a third conducting wire 35, wherein, the wiring box 34 is fixedly connected to a top part of the lamp body 1, and the third conducting wire 35 is configured to connect to the external power supply; here, an inner end of the third conducting wire 35 extends into the wiring box 34 and is electrically connected with the first conducting wire 2, in this way, the lamp body 1 forms an electrical connection with the external power supply. Of course, according to actual conditions and specific requirements, in other embodiments of the present invention, the aforesaid wiring component 3 can also be in other forms, and it is not uniquely restricted here.

Further wore, in the embodiment of the present invention, the aforesaid wiring component 3 further comprises a wiring sleeve 36, the wiring sleeve 36 is communicated with the aforesaid wiring box 34; meanwhile, an outer end of the aforesaid third conducting wire 35 inserts in and passes through the wiring sleeve 36, in other words, the third conducting wire 35 passes between the wiring sleeve 36 and the wiring box 34. By the arrangement of the wiring sleeve 36, a neatness of entire wiring of the downlight can be ensured, and thus it is convenient to assemble and maintain the downlight. Of course, according to actual conditions and specific requirements, in other embodiments of the present invention, the aforesaid wiring component 3 can also comprise other structural components, and it is not uniquely restricted here.

Furthermore, in the embodiment of the present invention, by contacting with a wiring nut 37, the aforesaid third conducting wire 35 and the aforesaid first conducting wire 2 form an electrical connection. Here, by electrically connecting the first conducting wire 2 with the third conducting wire 35 using the wiring nut 37, such that the first conducting wire 2 and the third conducting wire 35 can be assembled and disassembled rapidly and conveniently, and the electrical connection is stable and reliable. Of course, according to actual conditions and specific requirements, in other embodiments of the present invention, the aforesaid third conducting wire 35 and the aforesaid first conducting wire 2 can also be electrically connected by other methods, and it is not uniquely restricted here.

Furthermore, in the embodiment of the present invention, the aforesaid elastic member 4 is a V-shaped elastic piece, one side of the V-shape of the elastic piece 4 is fixedly connected to a side wall of the lamp body 1, and the other side of the V-shape extends outwards and obliquely. In assembly, the lamp body 1 is inserted into the mounting hole 90 of the ceiling 9, an outer side of the V-shape of the elastic member 4 elastically abuts against a hole wall of the mounting hole 90, thereby making the lamp body 1 be fixed in the mounting hole 90 of the ceiling 9. Of course, according to actual conditions and specific requirements, in other embodiments of the present invention, the elastic member 4 can also be in other structural forms, and it is not uniquely restricted here.

The aforesaid embodiment three is a complete substitution type of the compatible downlight, and an assembling process of the downlight is as follows:

Firstly, the ceiling 9 is machined to form the mounting hole 90, a thickness of the ceiling 9 can be 10-20 millimeters, in addition, a diameter of the mounting hole 90 can be five or six inches; thus, according to the requirement, a corresponding V-shaped elastic member 4 with a size of five or six inches is selected, and the tapping holes on corresponding positions of the V-shaped elastic member 4 are fixed with the lamp body 1 by screws; afterwards, one end of the wiring sleeve 36 is inserted into the wiring box 34 and then fixed; thus, an L electrode (live wire), an N electrode (naught wire), and a ground wire of the first conducting wire 2 in the lamp body 1 are respectively electrically connected with a mains supply L electrode, an N electrode, and a ground wire of the third conducting wire 35 in the wiring sleeve 36 by the wiring nut 37; finally, the wiring box 34 is fixed onto the lamp body 1, two distal ends of two outer sides of the V-shaped elastic member 4 are pressed by two hands, the elastic member 4 and the lamp body 1 are entirely inserted into the mounting hole 90 of the ceiling 9, and are slightly pushed by two hands until a circular surface at a bottom of the lamp body 1 abuts against the ceiling 9; at this moment, the whole downlight is completely assembled.

Based on the technical solutions of the aforesaid embodiment one, embodiment two, and embodiment three, the compatible downlights provided by the embodiments of the present invention can be mounted and fixed by the mounting cylinder (embodiment one and embodiment two, in which the half substitution types are illustrated), and can also be mounted and fixed without any mounting cylinder (embodiment three, in which the complete substitution type is illustrated), that is, the compatible downlight is compatible with both an assembly type with the mounting cylinder and an assembly type without any mounting cylinder; meanwhile, the compatible downlight is also compatible with assemblies using different hole diameters of mounting holes, that is, the hole diameters of the mounting holes can be adjusted according to actual requirements, so that using requirements of consumers are met, using cost is reduced, and experience effect of the consumers is improved. Moreover, according to mechanics theory, it is calculated that a force intensity of the elastic member 4 is positively proportional to a weight of a clamped object, and thus a rigidity of the elastic member 4 can be determined, such that components can be reliably and effectively fixed; the assembly is simple, convenient, safe, and reliable.

The aforementioned embodiments are only some specified embodiments of the present application, and should not be regarded as being limitation to the protection scope of the present invention; any one of ordinary skills in the present technical field can easily think of various equivalent modifications, replacements and improvements, and so on within the technical scope disclosed by the present invention, these modifications, replacements and improvements should be all included in the protection scope of the present invention. Therefore, the protection scope of the present invention should take the protection scope of the claims as the standard.

1. A compatible downlight mounted in a mounting hole of a ceiling, the compatible downlight comprises a lamp body and a first conducting wire led out from an inside of the lamp body and electrically connected with the lamp body, wherein, the compatible downlight further comprises a wiring component configured to connect with an external power supply and two elastic members configured for positioning and fixing the lamp body, each of the elastic members is fixedly connected to and detachable from the lamp body, and the first conducting wire is electrically connected to the wiring component.

2. The compatible downlight according to claim 1, further comprising a mounting cylinder which defines an opening at a bottom end thereof and is hollow, the mounting cylinder is mounted in the mounting hole of the ceiling, both the wiring component and the lamp body are arranged in the mounting cylinder, and a bottom surface of the lamp body blocks the opening of the mounting cylinder.

3. The compatible downlight according to claim 2, wherein, the wiring component comprises a lamp base arranged on an inner wall of a top end of the mounting cylinder, a lamp cap connected in the lamp base, and a second conducting wire electrically connected with the lamp cap, and the second conducting wire is electrically connected with the first conducting wire.

4. The compatible downlight according to claim 3, wherein, an outer end of the first conducting wire is provided with a female terminal, and an outer end of the second conducting wire is provided with a male terminal; or, the outer end of the first conducting wire is provided with a male terminal, and the outer end of the second conducting wire is provided with a female terminal; the male terminal is inserted in the female terminal to form an electrical connection.

5. The compatible downlight according to any one of claim 4, wherein, each of the elastic members comprises a first connecting sheet and two abutting elastic members integrally arranged at two sides of the first connecting sheet respectively, the first connecting sheet can be fixedly connected to and detached from an outer wall of the lamp body, and the two abutting elastic members abuts tightly against an inner wall of the mounting cylinder.

6. The compatible downlight according to any one of claim 4, wherein, an inner peripheral wall of the mounting cylinder protrudes to form two hangers, and the two elastic members are hung on the two hangers respectively.

7. The compatible downlight according to claim 6, wherein, each of the elastic members comprises a second connecting sheet and a torque spring arranged at an outer side of the second connecting sheet, and two support legs of the torque spring abut tightly against and fit with one of the hangers to form a hitching connection.

8. The compatible downlight according to claim 1, wherein, the wiring component comprises a wiring box arranged on a top part of the lamp body and a third conducting wire, and an inner end of the third conducting wire extends into the wiring box and is electrically connected with the first conducting wire.

9. The compatible downlight according to claim 8, wherein, the wiring component further comprises a wiring sleeve communicated with the wiring box, and an outer end of the third conducting wire inserts in and passes through the wiring sleeve.

10. The compatible downlight according to claim 8, wherein, the third conducting wire and the first conducting wire form the electrical connection through a wiring nut.

11. The compatible downlight according to claim 9, wherein, the third conducting wire and the first conducting wire form the electrical connection through a wiring nut.
